(19) United States
(12) Patent Application Publication
(10) Pub. No.: US 2008/0151438 A1
(43) Pub. Date: Jun. 26, 2008

(54) MAGNETORESISTIVE ELEMENT

(76) Inventors: Kenichi Tanaka, Niigata-ken (JP); Eiji Umetsu, Niigata-ken (JP); Kazuaki Ikarashi, Niigata-ken (JP); Kota Asatsuma, Niigata-ken (JP)

Correspondence Address: BRINKS HOFER GILSON & LIONE, P.O. BOX 10395, CHICAGO, IL, 60610, US

(21) Appl. No.: 11/946,266

(22) Filed: Nov. 28, 2007

(30) Foreign Application Priority Data
Dec. 21, 2006 (JP) 2006-343913

(51) Int. Cl. G11B 5/33

(52) U.S. Cl. 360/319

(57) ABSTRACT

The invention provides a magnetoresistive element including a seed layer having a flat surface, which makes it possible to improve the flatness of all of the elements. A seed layer is formed in a two-layer structure of a first seed layer that is formed on a lower shield layer and a second seed layer that is formed underneath an anti-ferromagnetic layer, and the second seed layer is formed of ruthenium (Ru). According to this structure, the flatness of the surface of the seed layer is improved, which makes it possible to improve the flatness of interfaces between layers of an element formed on the seed layer. As a result, it is possible to manufacture a magnetoresistive element having a high dielectric breakdown voltage and high operational reliability.

### CLAIM OF PRIORITY

This application claims benefit of the Japanese Patent Application No. 2006-343913 filed on Dec. 21, 2006, the entire content of which is hereby incorporated by reference.

### BACKGROUND OF THE INVENTION

1. Field of the Invention

The present invention relates to a magnetoresistive element that is used for a magnetic head provided in a hard disk device, a magnetic sensor, or an MRAM (magnetoresistive RAM), and more particularly, to a magnetoresistive element capable of improving the flatness of interfaces between a non-magnetic material layer and other layers while appropriately maintaining a seed effect, and improving operational stability.

2. Description of the Related Art

In general, tunneling magnetoresistive elements have a laminated structure of an anti-ferromagnetic layer, a pinned magnetic layer, an insulating barrier layer, and a free magnetic layer in this order from the bottom. A seed layer is formed on a substrate, or a base layer formed on the substrate, and the anti-ferromagnetic layer, the pinned magnetic layer, the free magnetic layer, and the non-magnetic material layer are sequentially formed on the seed layer.

The seed layer is formed of a material capable of giving good crystal orientation to the anti-ferromagnetic layer, the pinned magnetic layer, the insulating barrier layer, and the free magnetic layer formed on the seed layer and increasing the diameters of crystal particles, that is, a material having a seed effect. For example, when the crystal structure of the seed layer is a face centered cubic (fcc) structure and an equivalent crystal surface, which is represented as a {111} plane, is preferentially aligned in a direction parallel to a film surface, it is possible to align the layers formed on the seed layer as {111} planes of the face centered cubic (fcc) structure and increase the diameters of crystal particles. In this way, it is possible to improve the rate of resistance change (ΔR/R).

A magnetoresistive element disclosed in JP-A-2002-76473 includes a seed layer formed of NiFeCr.

It has been known that the seed layer formed of NiFeCr makes it possible to appropriately improve the crystal orientation of layers formed on the seed layer and improve the rate of resistance change (ΔR/R).

However, when the seed layer is formed of NiFeCr, the flatness of an interface between the insulating barrier layer and the pinned magnetic layer and the flatness of an interface between the insulating barrier layer and the free magnetic layer deteriorate. As a result, the thickness of the insulating barrier layer becomes non-uniform, and a portion of the insulating barrier layer has a small thickness. In this case, even though a low voltage is applied, a dielectric breakdown occurs in the insulating barrier layer. The element having a low dielectric breakdown voltage (BDV) has low operational stability and low operational reliability.

Further, when the flatness of the interface deteriorates, noise is generated from a reproducing head, which lowers the operational stability.

Furthermore, when the seed layer is composed of a single layer formed of NiCr or Cr, the above-mentioned problems also arise.

### SUMMARY

According to an aspect of the invention, a magnetoresistive element includes: a lower shield layer; and a seed layer, an anti-ferromagnetic layer, a first magnetic layer, a non-magnetic material layer, and a second magnetic layer that are sequentially formed on the lower shield layer in this order from the bottom. In the magnetoresistive element, the magnetization of the second magnetic layer varies due to an external magnetic field, and the seed layer has a two-layer structure of a first seed layer, which is a lower layer, and a second seed layer. The first seed layer is formed of at least chromium (Cr), and the second seed layer is formed of ruthenium (Ru).

According to the above-mentioned structure, the seed layer is formed in a two-layer structure. In the seed layer, the first seed layer, which is a lower seed layer, is formed of a material containing at least Cr, and the second seed layer, which is an upper seed layer, is formed of Ru. In this way, it is possible to improve the flatness of interfaces between the non-magnetic material layer and other layers. As a result, it is possible to reduce noise while maintaining a good seed effect, which results in high operational stability.

In the magnetoresistive element according to the above-mentioned aspect, preferably, the first seed layer is formed of nickel-iron-chromium (NiFeCr). When the seed layer is formed in a structure of NiFeCr/Ru, it is possible to effectively improve operational stability while maintaining a good seed effect.

### BRIEF DESCRIPTION OF THE DRAWINGS

FIG. 1 is a cross-sectional view illustrating a tunneling magnetoresistive element according to an embodiment of the disclosure, which is taken in a direction parallel to a surface facing a recording medium.

FIG. 2 is a diagram illustrating a process of a method of manufacturing the tunneling magnetoresistive element according to the embodiment (a cross-sectional view illustrating the tunneling magnetoresistive element during a manufacturing process, which is taken in the direction parallel to the surface facing a recording medium).

FIG. 3 is a diagram illustrating a process subsequent to the process shown in FIG. 2 (a cross-sectional view illustrating the tunneling magnetoresistive element during the manufacturing process, which is taken in the direction parallel to the surface facing a recording medium).

FIG. 4 is a diagram illustrating a process subsequent to the process shown in FIG. 3 (a cross-sectional view illustrating the tunneling magnetoresistive element during the manufacturing process, which is taken in the direction parallel to the surface facing a recording medium).

FIG. 5 shows a TEM photograph illustrating the cross section of a laminate T1 formed according to Example 1.

FIG. 6 shows a TEM photograph illustrating the cross section of a laminate T1 formed according to Comparative example 1.

### DESCRIPTION OF THE EMBODIMENTS

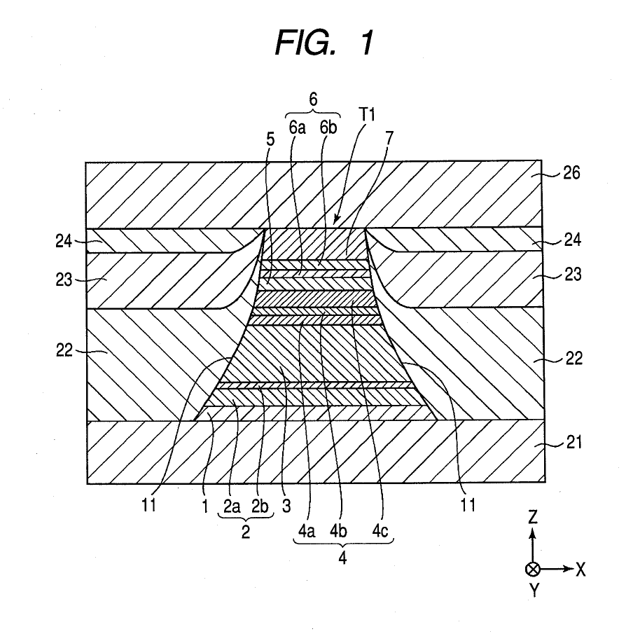

FIG. 1 is a cross-sectional view illustrating a tunneling magnetic detecting element (a tunneling magnetoresistive element) according to an embodiment of the invention, which is taken in a direction parallel to a surface facing a recording medium.

The tunneling magnetoresistive element is provided on a trailing surface of a magnetic levitation slider provided in a hard disk device, and detects a recording magnetic field of a hard disk. In the drawings, an X-axis direction indicates a track width direction, a Y-axis direction indicates the direction of a leakage magnetic field from a magnetic recording medium (height direction), and a Z-axis direction indicates a direction in which a magnetic recording medium, such as a hard disk, moves and a direction in which layers of the tunneling magnetoresistive element are laminated.

A lower shield layer 21 formed of, for example, a NiFe alloy is formed as the lowest layer in FIG. 1. A laminate T1 is formed on the lower shield layer 21. Both side surfaces 11 of the laminate T1 in the track width direction (the X-axis direction in the drawings) are inclined such that the width thereof in the track width direction is gradually reduced in the upward direction. That is, the laminate T1 is formed in a substantially trapezoidal shape.

The tunneling magnetoresistive element includes the laminate T1, and a lower insulating layer 22, a hard bias layer 23, and an upper insulating layer 24 formed at both sides of the laminate T1 in the track width direction (the X-axis direction in the drawings).

The lowest layer of the laminate T1 is a base layer 1 that is formed of at least one kind of non-magnetic material selected from Ta (tantalum), Hf (hafnium), Nb (niobium), Zr (zirconium), Ti (titanium), Mo (molybdenum), and W (tungsten). Particularly, when the base layer 1 is formed of Ta, it is easy to planarize the surface of the base layer 1, and the flatness of layers formed on the base layer 1, such as a seed layer, is improved. The base layer 1 need not be formed.

A seed layer 2 is formed on the base layer 1. The seed layer 2 is formed in a two-layer structure of a first seed layer 2a formed on the base layer 1 and a second seed layer 2b formed on the first seed layer 2a. In addition, the second seed layer 2b comes into contact with an anti-ferromagnetic layer 3 formed on the seed layer 2.

The first seed layer 2a is formed of NiFeCr, NiCr, or Cr. It is preferable that the first seed layer 2a be formed of NiFeCr. When the first seed layer 2a is formed of NiFeCr, the first seed layer 2a has a face centered cubic (fcc) structure, and an equivalent crystal surface, which is represented as a {111} surface, is preferentially aligned in the direction parallel to a film surface. Therefore, the layers formed on the first seed layer 2a have the face centered cubic (fcc) structure since an equivalent crystal surface having the {111} surface in the direction parallel to the film surface is likely to be preferentially aligned.

It is preferable that the thickness of the first seed layer 2a be larger than about 30 Å. When the thickness of the first seed layer 2a is smaller than about 30 Å, it is difficult to appropriately improve the crystal orientation of the layers formed on the first seed layer 2a. That is, the first seed layer 2a does not exhibit a sufficient seed effect to preferentially align the crystal surfaces of the layers formed on the first seed layer 2a on the crystal surface of the first seed layer 2a and to increase the diameter of crystal particles, which results in a reduction in the rate of resistance change (ΔR/R). Therefore, it is preferable that the thickness of the first seed layer 2a be larger than about 30 Å. However, since the thickness of the tunneling magnetoresistive element is preferably as small as possible, the thickness of the first seed layer 2a is preferably in a range of about 40 to about 60 Å. In this embodiment, the first seed layer 2a has a thickness of, for example, about 50 Å.

The second seed layer 2b formed of Ru (ruthenium) is provided on the first seed layer 2a. The crystal structure of Ru is a hexagonal closest packing (hcp) structure. However, when Ru is formed on the first seed layer 2a so as to overlap with each other, the crystal structure of Ru may be changed. Even when the second seed layer 2b formed of Ru is provided on the first seed layer 2a containing Cr, it is possible to obtain the same seed effect as that in the related art in which only the first seed layer 2a is formed, and thus obtain a high rate of resistance change (ΔR/R).

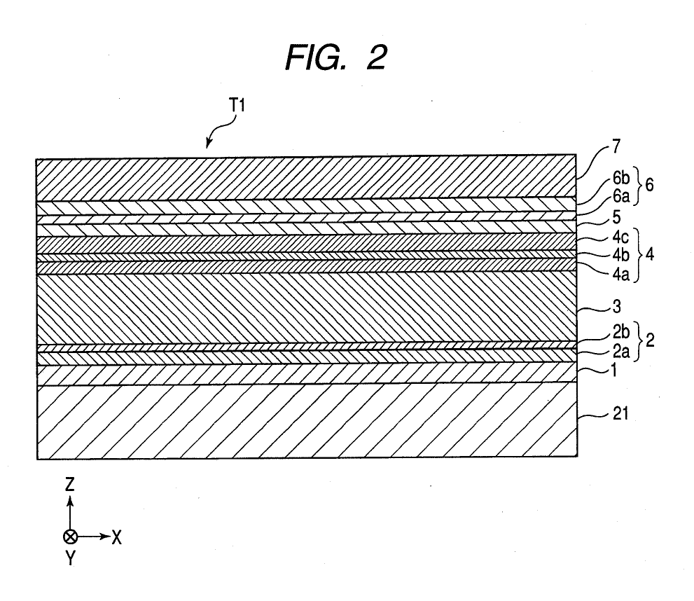

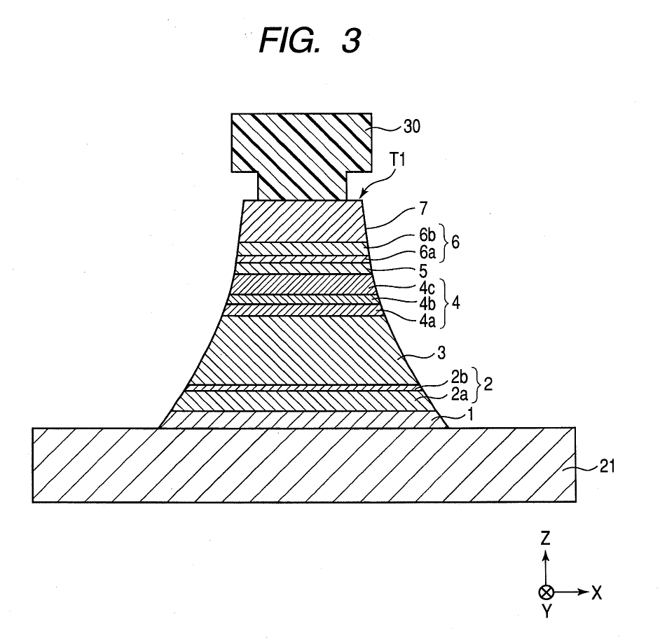

The thickness of the second seed layer 2b formed of Ru is preferably smaller than that of the first seed layer 2a. Specifically, the thickness of the second seed layer 2b is preferably smaller than about 30 Å. The tunneling magnetoresistive element is formed as follows: as shown in FIG. 2, layers are laminated to form the laminate T1; and, as shown in FIG. 3, the side of the laminate T1 is etched to be tapered toward the top such that the width of both side surfaces 11 in the track width direction is gradually reduced in the upward direction, thereby forming a substantially trapezoidal laminate T1 as an element. The etched Ru particles are adhered to the side surfaces of the laminate T1. The larger the thickness of the Ru film becomes, the more the amount of Ru particles adhered to the laminate T1 becomes. When the thickness of the second seed layer 2b formed of Ru is larger than about 30 Å, a short circuit is likely to occur due to the Ru particles adhered to the side surface of the insulating barrier layer, which results in low operational stability. When the worst, it is impossible to perform reproduction. For this reason, the second seed layer 2b is formed of Ru with a small thickness. In this embodiment, as described above, it is preferable that the thickness of the second seed layer 2b be smaller than about 30 Å. In this embodiment, the second seed layer 2b is formed with a thickness of about 10 Å.

The anti-ferromagnetic layer 3 formed on the seed layer 2 is preferably formed of an anti-ferromagnetic material containing an element X (where X is at least one kind of element selected from Pt, Pd, Ir, Rh, Ru, and Os) and Mn.

An X—Mn alloy of platinum group elements is an anti-ferromagnetic material having high characteristics, such as high corrosion resistance, high blocking temperature, and a strong exchange coupling magnetic field (Hex). Among these platinum group elements, it is preferable to use Ir or Pt since it exhibits a high degree of anti-ferromagnetism. In this embodiment, IrMn is used

The anti-ferromagnetic layer 3 may be formed of an anti-ferromagnetic material containing Mn, an element X, and an element X′ (where the element X′ is at least one kind of element selected from Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and a rare-earth element).

When the thickness of the anti-ferromagnetic layer 3 is small, the anti-ferromagnetism does not appear. Therefore, it is preferable that the thickness of the anti-ferromagnetic layer 3 be larger than about 40 Å.

A pinned magnetic layer 4 is formed on the anti-ferromagnetic layer 3. The pinned magnetic layer 4 has a laminated ferri structure including a first pinned magnetic layer 4a, a non-magnetic intermediate layer 4b, and a second pinned magnetic layer 4c in this order from the bottom. The magnetization directions of the first pinned magnetic layer 4a and the second pinned magnetic layer 4c are anti-parallel to each other due to an exchange coupling magnetic field generated from an interface between the anti-ferromagnetic layer 3 and the pinned magnetic layer 4 and an anti-ferromagnetic exchange coupling magnetic field (RKKY interaction) between the first and second pinned magnetic layers 4a and 4c through the non-magnetic intermediate layer 4b. This is called a laminated ferri structure, which makes it possible to stabilize the magnetization of the pinned magnetic layer 4 and strengthen the exchange coupling magnetic field generated from an interface between the pinned magnetic layer 4 and the anti-ferromagnetic layer 3. In addition, the first pinned magnetic layer 4a and the second pinned magnetic layer 4c are formed with a thickness of, for example, about 12 Å to about 24 Å, and the non-magnetic intermediate layer 4b is formed with a thickness of about 8 Å to about 10 Å.

The first pinned magnetic layer 4a and the second pinned magnetic layer 4c are formed of a ferromagnetic material, such as CoFe, NiFe, or CoFeNi. The non-magnetic intermediate layer 4b is formed of a non-magnetic conductive material, such as Ru, Rh, Ir, Cr, Re, or Cu.

The insulating barrier layer 5 formed on the pinned magnetic layer 4 is preferably formed of a titanium oxide (Ti—O), an aluminum oxide (Al—O), or a magnesium oxide (Mg—O). The insulating barrier layer 5 can be formed by a sputtering method using a target composed of Ti—O, Al—O or Mg—O. In addition, in the case of Ti—O or Al—O, a film may be formed of Ti or Al with a thickness of 1 to 10 Å, and the film may be oxidized to obtain Ti—O or Al—O. In this case, since the film is oxidized, the film is formed with a large thickness. However, finally, the thickness of the insulating barrier layer 5 is preferably in a range of about 1 to about 20 Å. When the thickness of the insulating barrier layer 5 is excessively large, it is not preferable since it is difficult for a tunneling current to flow.

A free magnetic layer 6 is formed on the insulating barrier layer 5. The free magnetic layer 6 includes a soft magnetic layer 6b that is formed of a magnetic material, such as a NiFe alloy, and an enhancing layer 6 that is formed of, for example, a CoFe alloy and is interposed between the soft magnetic layer 6b and the insulating barrier layer 5. The soft magnetic layer 6b is preferably formed of a magnetic material having a high soft magnetic characteristic, and the enhancing layer 6a is preferably formed of a magnetic material having higher spin polarizability than the soft magnetic layer 6b. When the soft magnetic layer 6b is formed of a NiFe alloy, it is preferable that, from the viewpoint of magnetic characteristics, the content of Ni be in a range of about 80 to 100 at %.

When the enhancing layer 6a abutting on the insulating barrier layer 5 is formed of a CoFe alloy having high spin polarizability, it is possible to improve the rate of resistance change (ΔR/R). In particular, since the CoFe alloy containing a high percentage of Fe has high spin polarizability, it is effective to improve the rate of resistance (ΔR/R) of an element. Since an element having a high rate of resistance change (ΔR/R) has high detection sensitivity, it can improve the characteristics of a reproducing head. The content of Fe in the CoFe alloy is not limited to a specific value, but it is preferable that the content of Fe in the CoFe alloy be in a range of about 10 to about 90 at %.

Further, when the thickness of the enhancing layer 6a is excessively large, the enhancing layer 6a has an effect on the magnetic detection sensitivity of the soft magnetic layer 6b, which results in a low detection sensitivity. Therefore, the thickness of the enhancing layer 6a is smaller than that of the soft magnetic layer 6b. For example, the soft magnetic layer 6b is formed with a thickness of about 30 to about 70 Å, and the enhancing layer 6a is formed with a thickness of about 10 Å. In addition, the thickness of the enhancing layer 6a is preferably in a range of about 6 to about 20 Å.

The free magnetic layer 6 may have a laminated ferri structure including a plurality of magnetic layers and non-magnetic intermediate layers interposed between the magnetic layers. A track width Tw may be determined by the width of the free magnetic layer 6 in the track width direction (the X-axis direction in the drawings).

A protective layer 7 formed of, for example, Ta is provided on the free magnetic layer 6.

In this way, the laminate T1 is formed on the lower shield layer 21. The two side surfaces 11 of the laminate T1 in the track width direction (the X-axis direction in the drawings) are etched into inclined surfaces such the width thereof in the track width direction is gradually reduced in the upward direction.

As shown in FIG. 1, the lower insulating layer 22 is formed on the lower shield layer 21 formed below the laminate T1 so as to abut on the two side surfaces 11 of the laminate T1, and the hard bias layer 23 is formed on the lower insulating layer 22. In addition, the upper insulating layer 24 is formed on the hard bias layer 23.

A bias base layer (not shown) may be formed between the lower insulating layer 22 and the hard bias layer 23. In this case, the bias base layer is formed of, for example, Cr, W, or Ti.

The insulating layers 22 and 24 are formed of an insulating material, such as Al₂O₃ or SiO₂, and insulate the hard bias layer 23 in order to prevent a current flowing through the laminate T1 in the vertical direction of interfaces among the layers from branching to both sides of the laminate T1 in the track width direction. The hard bias layer 23 is formed of, for example, a Co—Pt (cobalt-platinum) alloy or a Co—Cr—Pt (cobalt-chromium-platinum) alloy.

The upper shield layer 26 made of, for example, a NiFe alloy is formed on the laminate T1 and the upper insulating layer 24.

In the embodiment shown in FIG. 1, the lower shield layer 21 and the upper shield layer 26 serve as electrode layers of the laminate T1, and a current flows through the laminate T1 in the vertical direction (in the direction parallel to the Z-axis direction in the drawings) of the surfaces of the layers.

The free magnetic layer 6 is magnetized in the direction (the X-axis direction in the drawings) parallel to the track width direction when receiving a bias magnetic field from the hard bias layer 23. Meanwhile, the first pinned magnetic layer 4a and the second pinned magnetic layer 4c of the pinned magnetic layer 4 are magnetized in the direction (the Y-axis direction in the drawings) parallel to the height direction. Since the pinned magnetic layer 4 has the laminated ferri structure, the first pinned magnetic layer 4a and the second pinned magnetic layer 4c are magnetized in anti-parallel to each other. The magnetization of the pinned magnetic layer 4 is fixed (there is no change in magnetization due to an external magnetic field), but the magnetization of the free magnetic layer 6 varies due to the external magnetic field.

If the magnetization of the free magnetic layer 6 varies due to the external magnetic field, it is difficult for a tunneling current to flow through the insulating barrier layer 5 interposed between the second pinned magnetic layer 4c and the free magnetic layer 6, when the second pinned magnetic layer 4c and the free magnetic layer 6 are magnetized in anti-parallel to each other. As a result, the resistance is maximized. Meanwhile, when the second pinned magnetic layer 4c and the free magnetic layer 6 are magnetized in parallel to each other, the tunneling current is more likely to flow, and thus the resistance is minimized.

According to this principle, when the magnetization of the free magnetic layer 6 varies due to the external magnetic field, the variation in the electric resistance is detected as a voltage variation, which makes it possible to detect a leakage magnetic field from a recording medium.

In the tunneling magnetoresistive element according to this embodiment, the seed layer 2 has a two-layer structure of the first seed layer 2a formed on the base layer 1 and the second seed layer 2b that is formed of Ru and laminated on the first seed layer 2a. The second seed layer 2b is formed underneath the anti-ferromagnetic layer 3.

In the tunneling magnetoresistive element according to this embodiment, the second seed layer 2b formed of Ru is laminated on the first seed layer 2a containing at least Cr. In this way, it is possible to improve the flatness of the interface between the insulating barrier layer 5 and the pinned magnetic layer 4, and the flatness of the interface between the insulating barrier layer 5 and the free magnetic layer 6, while maintaining the seed effect. Therefore, it is possible to form the insulating barrier layer 5 with a uniform thickness, increase a dielectric breakdown voltage (BDV) as compared to the related art, and prevent a variation in the dielectric breakdown voltage (BDV). In addition, it is possible to improve the flatness of an interface between the layers and thus prevent the occurrence of noise. As a result, it is possible to manufacture a magnetoresistive element having high operational stability and high operational reliability.

In this embodiment, when the first seed layer 2a is formed on the second seed layer 2b, it is difficult to appropriately exhibit the seed effect of the first seed layer 2a, which results in a low rate of resistance change (ΔR/R). Therefore, as in this embodiment, the second seed layer 2b formed of Ru is laminated on the first seed layer 2a containing at least Cr.

Further, it is preferable that the first seed layer 2a be formed of NiFeCr. In this case, it is possible to effectively increase the dielectric breakdown voltage (BDV) and prevent a variation in the dielectric breakdown voltage (BDV), as compared to the related art in which the seed layer is formed of only NiFeCr.

In this embodiment, the tunneling magnetoresistive element is used, but the invention is not limited thereto. The invention can be applied to other magnetoresistive elements, such as AMR and GMR elements. In this case, it is possible to manufacture a magnetoresistive element capable of improving the flatness of an interface between a non-magnetic material layer formed of, for example, Cu and other layers while maintaining a good seed effect, reducing the occurrence of noise as compared to the related art, and improving operational stability.

Next, a method of manufacturing the tunneling magnetoresistive element according to this embodiment will be described below. FIGS. 2 to 4 are partial cross-sectional views illustrating a tunneling magnetoresistive element during a manufacturing process, which are taken in the same direction as that in FIG. 1.

In the process shown in FIG. 2, the base layer 1 is formed on the lower shield layer 21, and the first seed layer 2a and the second seed layer 2b formed of Ru are sequentially laminated on the base layer 1. In addition, the anti-ferromagnetic layer 3, the first pinned magnetic layer 4a, the non-magnetic intermediate layer 4b, and the second pinned magnetic layer 4c are sequentially formed on the seed layer 2.

Then, a metal layer made of Ti or Al is formed on the second pinned magnetic layer 4c by, for example, a sputtering method. Since the metal layer will be oxidized in a subsequent process, the metal film is formed such that the thickness thereof after oxidization is equal to that of the insulating barrier layer 5.

Then, oxygen flows into a vacuum chamber. Then, the metal layer is oxidized, and the insulating barrier layer 5 is formed. The oxidizing methods include a radical oxidation method, an ion oxidation method, a plasma oxidation method, and a natural oxidation method.

Instead of the metal layer, a semiconductor layer may be formed, and the semiconductor layer may be oxidized to form the insulating barrier layer 5. In addition, instead of the metal layer, a metal oxide layer formed of Ti—O, Al—O or Mg—O may be formed by a sputtering method. In this case, the subsequent oxidizing process is not needed.

Then, the free magnetic layer 6 including the enhancing layer 6a and the soft magnetic layer 6b is formed on the insulating barrier layer 5. Subsequently, the protective layer 7 is formed on the free magnetic layer 6. In this way, the laminate T1 composed of the layers from the lowermost base layer 1 to the uppermost protective layer 7 is formed.

Then, a lift-off resist layer 30 is formed on the laminate T1, and both edges of the laminate T1 in the track width direction (the X-axis direction in the drawings), which are not covered with the lift-off resist layer 30, are removed by, for example, etching (see FIG. 3).

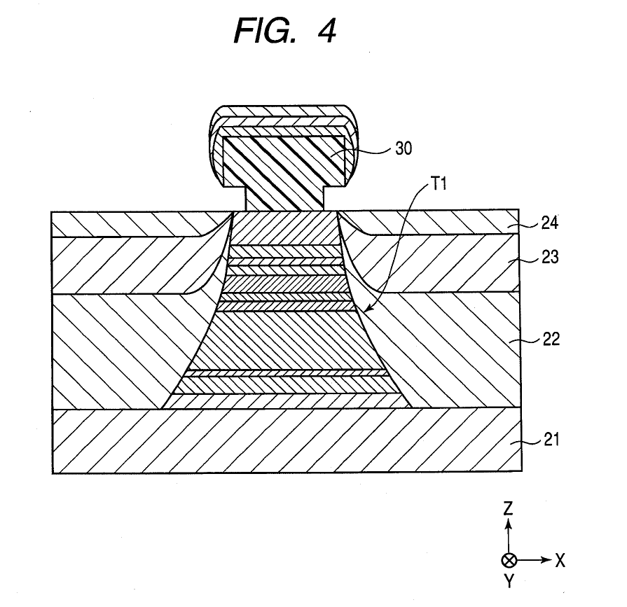

Next, the lower insulating layer 22, the hard bias layer 23, and the upper insulating layer 24 are sequentially formed on the lower shield layer 21 in this order from the bottom, at both sides of the laminate T1 in the track width direction (the X-axis direction in the drawings) (see FIG. 4).

Then, the lift-off resist layer 30 is removed to form the upper shield layer 26 on the laminate T1 and the upper insulating layer 24.

The method of manufacturing the tunneling magnetoresistive element includes an annealing process. The annealing process is generally used to generate an exchange coupling magnetic field (Hex) between the anti-ferromagnetic layer 3 and the first pinned magnetic layer 4a.

In this embodiment, the first seed layer 2a is formed of, for example, NiFeCr containing at least Cr, and the second seed layer 2b is formed of Ru.

According to the above-mentioned structure, it is possible to improve the flatness of interfaces between the insulating barrier layer 5 and other layers while maintaining a good seed effect. As a result, it is possible to easily manufacture a tunneling magnetoresistive element having a high rate of resistance change (ΔR/R), a high dielectric breakdown voltage (BDV), and high operational reliability.

The magnetoresistive element according to this embodiment can be applied to magnetic sensors and MRAMs (magnetoresistive random access memories) in addition to the magnetic head provided in a hard disk device.

### EXAMPLES

### Example 1

The tunneling magnetoresistive element shown in FIG. 1 is formed.

The laminate T1 is formed by laminating the base layer 1 (Ta(30)), the first seed layer 2a (NiFeCr(50)), the second seed layer 2b (Ru(10)), the anti-ferromagnetic layer 3 (IrMn(70)), the pinned magnetic layer 4 including the first pinned magnetic layer 4a (CoFe(14)), the non-magnetic intermediate layer 4b (Ru(9)), and the second pinned magnetic layer 4c (CoFe(18)), and the metal layer (Al(4.3)) in this order from the bottom. In this case, the numerical value in the parentheses indicates an average film thickness (Å). Then, the metal film is oxidized to form the insulating barrier layer 5 formed of Al—O. The free magnetic layer 6 (CoFe(10)/NiFe(50)) and the protective layer 7 (Ru(20)/Ta(270)) are sequentially formed on the insulating barrier layer 5.

Then, the annealing process is performed on the laminate T1 at 270° C. for 220 minutes, and the lower insulating layer 22, the hard bias layer 23, and the upper insulating layer 24 are formed on the laminate T to manufacture a tunneling magnetoresistive element.

Then, the annealing process is performed on the laminate T1 at 270° C. for 220 minutes, and the lower insulating layer 22, the hard bias layer 23, and the upper insulating layer 24 are formed on the laminate T to manufacture a tunneling magnetoresistive element.

### Comparative Example 1

A tunneling magnetoresistive element according to Comparative example 1 is similar to that according to Example 1 except that the second seed layer 2b is not formed and the seed layer 2 is composed of only the first seed layer 2a (NiFeCr(50)). The tunneling magnetoresistive element according to Comparative example 1 has the structure shown in FIG. 1.

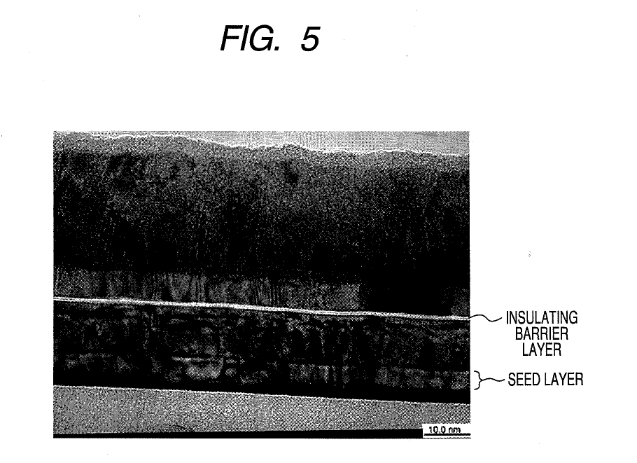

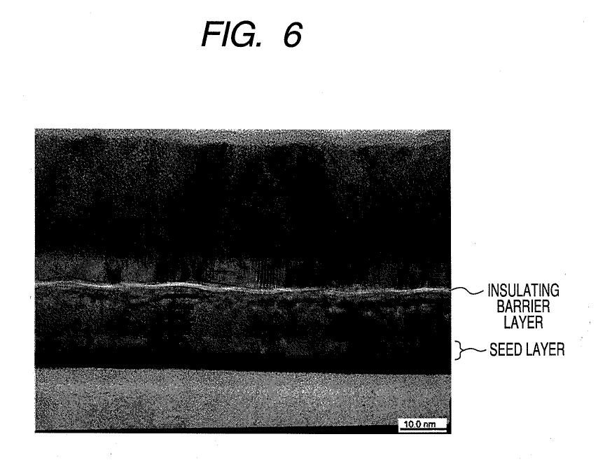

FIGS. 5 and 6 show TEM photographs illustrating the cross sections of the laminates T1 according to Example 1 and Comparative 1. It seems that there is little difference between the flatnesses of the seed layers according to Example 1 and Comparative example 1. However, as looking at a white portion in the middle of FIG. 5, which is the insulating barrier layer 5, closely, the insulating barrier layer 5 according to Example 1 shown in FIG. 5 extends substantially in a straight line and has a substantially uniform thickness, but the insulating barrier layer 5 according to Comparative example 1 shown in FIG. 6 extends in zigzag in the vertical direction and has a non-uniform thickness. The comparison shows that Example 1 in which the second seed layer 2b formed of Ru is laminated on the first seed layer 2a formed of NiFeCr makes it possible to planarize the layers formed on the seed layer.

Next, the dielectric breakdown voltages (BDV) of seven examples, that is, elements according to Example 1 and Comparative example 1 are measured while gradually increasing a voltage applied to the samples. The measured results are shown in Table 1. As can be seen from Table 1, when the dielectric breakdown voltage (BDV) is higher than 500 mV, high operational reliability is obtained. In contrast, when the BDV is lower than 500 mV, low operational reliability is obtained. In this case, the seven samples are selected from a plurality of elements according to Example 1 and Comparative Example 1 by random sampling. The elements are formed on the same substrate by the same manufacturing process.

TABLE 1

| | | | Dielectric breakdown voltage (BDV (mV)) | | | | | | | | |
|---|---|---|---|---|---|---|---|---|---|---|---|
| | | Second seed | | | | | | | | | Standard |
| | First seed layer | layer | Sample 1 | Sample 2 | Sample 3 | Sample 4 | Sample 5 | Sample 6 | Sample 7 | Average | deviation |
| Example 1 | NiFe | Ru | 680 | 680 | 690 | 680 | 700 | 690 | 700 | 689 | 9.0 |
| | Cr | (10 Å) | | | | | | | | | |
| | (50 Å) | | | | | | | | | | |
| Comparative | NiFe | Nothing | 650 | 400 | 600 | 610 | 400 | 350 | 640 | 521 | 131.3 |
| example 1 | Cr | | | | | | | | | | |
| | (50 Å) | | | | | | | | | | |

As can be seen from Table 1, the elements according to Example 1 have a dielectric breakdown voltage of 680 to 700 mV and thus have high operational reliability (the average of the dielectric breakdown voltages of seven elements is 689 mV), and little variation in the dielectric breakdown voltage occurs in the elements (the standard deviation of seven elements is 9 mV). Meanwhile, the elements according to Comparative example 1 have a dielectric breakdown voltage (BDV) of 600 to 650 mV and thus have high operational reliability. However, the dielectric breakdown voltages (BDV) of the elements are not constant, and the dielectric breakdown occurs in three of the seven samples when a voltage of 350 to 400 mV is applied. The average of the dielectric breakdown voltages (BDV) of the seven elements is 521 mV, and the standard deviation thereof is 131.3 mV. This shows that the elements according to Example 1 have a high dielectric breakdown voltage (BDV), a small variation in the dielectric breakdown voltage, and high operational reliability. In addition, as can be seen from Table 1, the elements according to Example 1 and the elements according to Comparative example 1 all have about 30% of the rate of resistance change (ΔR/R), and both Example 1 and Comparative example 1 have a high degree of seed effect.

1. A magnetoresistive element comprising:
a lower shield layer; and
a seed layer, an anti-ferromagnetic layer, a first magnetic layer, a non-magnetic material layer, and a second magnetic layer that are sequentially formed on the lower shield layer in this order from the bottom,
wherein the magnetization of the second magnetic layer varies due to an external magnetic field,
the seed layer has a two-layer structure of a first seed layer, which is a lower layer, and a second seed layer,
the first seed layer comprises at least chromium (Cr), and the second seed layer comprises ruthenium (Ru).

2. The magnetoresistive element according to claim 1,
wherein the first seed layer comprises nickel-iron-chromium (NiFeCr).

3. The magnetoresistive element according to claim 1,
wherein the first seed layer comprises nickel-chromium (NiCr), or chromium (Cr).

4. The magnetoresistive element according to claim 1,
wherein the thickness of the second seed layer is smaller than that of the first seed layer.

5. The magnetoresistive element according to claim 1,
wherein the first magnetic layer is a pinned magnetic layer whose magnetization direction is fixed,
the second magnetic layer is a free magnetic layer whose magnetization varies due to the external magnetic field, and
the non-magnetic material layer comprises an insulating material.
